(19) United States
(12) Patent Application Publication
(10) Pub. No.: US 2008/0268772 A1
(43) Pub. Date: Oct. 30, 2008

(54) Personalized radio engine for mobile devices

(75) Inventors: Mikko Linnamaki, Stuttgart (DE); Tero Katajainen, Helsinki (FI)

Correspondence Address: CARR & FERRELL LLP, 2200 GENG ROAD, PALO ALTO, CA, 94303, US

(73) Assignee: Liquid Air Lab GmbH

(21) Appl. No.: 11/796,187

(22) Filed: Apr. 27, 2007

(51) Int. Cl. H04H 1/00

(52) U.S. Cl. 455/3.04; 455/412.1

(57) ABSTRACT

A method for providing a personalized radio experience on a mobile device is provided. The method comprises receiving an indication of a musical preference from a user of a mobile device. A song list is generated based at least in part on the musical preference. The song list comprises an identifier of a song associated with the musical preference. Header files associated with one or more radio broadcasts are scanned. A radio broadcast having the identifier in its header file is selected. A link associated with the radio broadcast is transmitted to the mobile device. The song list may be may be modified based on feedback received from the mobile device.

### BACKGROUND

1. Field of the Present Invention

The present invention relates generally to providing media to a mobile device and more specifically to a personalized radio engine for mobile devices.

2. Description of the Related Art

Currently, people are able to listen to streaming radio broadcasts on the Internet. Online radio broadcasts are typically accessible for free. However, these radio broadcasts can be difficult to browse or navigate to. Further, very little information may be provided to a user regarding type of playlist, genre, broadcasting hours, or the like.

There are also music services such as Rhapsody or Pandora available online. These services are typically subscription services for which a user may pay a monthly fee. Typically, a user is able to enter a musical preference, such as a favorite artist, and a playlist is generated containing songs based on the preference. The music service typically accesses a licensed copy of each song to be played and transmits the song to the user. Thus, by generating the playlist and licensing each song, the music service plays each song in a predetermined order.

Satellite radio services, such as XM or Sirius, also allow a user to select a favorite song and/or artist. When a station within the satellite radio service plays the favorite song or a song by the favorite artist, the user is alerted and given the option to change to the station playing the song. However, this service is limited to the selected artist and/or song and does not include similar songs or artists. Users of the satellite radio services also generally pay a monthly subscription fee to access the satellite radio stations.

Hence, there is a need for a mobile application that simplifies accessing and playing personalized audio content on a mobile device using online radio broadcasts. Further, there is a need for an application that simplifies selecting music preferences or radio stations on a mobile device.

### SUMMARY OF THE INVENTION

The present invention provides a method for providing a personalized radio engine on a mobile device. In one embodiment, the method begins by receiving a musical preference from a user of a mobile device. The preference may include a song, artist and/or genre or mood (e.g., sad, happy, or chilled). A song list is generated based on the musical preference which includes one or more identifiers of songs associated with the musical preference. Header files associated with one or more radio broadcasts are scanned, and a radio broadcast having one of the song identifiers in its header files is selected. A link associated with the radio broadcast is transmitted to the mobile device, and a menu indicating the song may be generated on the mobile device. If an instruction is received from the user to play the radio broadcast, the mobile device then accesses the radio broadcast.

Various embodiments of the invention and several alternatives are disclosed. One embodiment of the present invention provides a system and a method for receiving a personalized music service based on online radio broadcasts on a mobile device. Another embodiment provides a system and method for receiving radio content using the personalized music service on the mobile device. Still another embodiment consolidates processes for selecting online radio broadcasts on a mobile device.

### BRIEF DESCRIPTION OF DRAWINGS

In the attached drawings:

FIG. 1 is a block diagram of a network environment in which various embodiments of the present invention may be practiced;

FIG. 2 is a block diagram showing the principal components of a mobile device according to various embodiments of the present invention;

FIG. 3 is a flowchart showing the major steps of providing a personalized music service based on multiple online radio broadcasts to a mobile device according to various embodiments of the invention; and

FIG. 4 is a flowchart showing the major steps of receiving a personalized music service based on multiple radio broadcasts on a mobile device according to various embodiments of the invention.

### DETAILED DESCRIPTION

The present invention-provides a personalized music experience to a user of a mobile device using radio broadcasts accessible via the Internet. The present invention provides an application that can be installed on a mobile device and servers for providing data used by the application to the mobile device. In some embodiments, the application is configured to receive a musical preference from the user. A song list is generated based on the musical preference. The server is configured to scan header files that include information about a song playing on each accessible radio broadcast. If the song indicated by the header file matches a song in the playlist, the server transmits a message to the mobile device indicating the song and/or identifying the radio broadcast. Based on a user selection, the mobile device receives streaming audio data from the radio broadcast.

The application allows a user of a mobile device to easily navigate to a URL associated with a radio broadcast based on a song being played on the radio broadcast. The server, rather than the user, provides URLs, additional search criteria, song lists, or the like. This allows the user to easily navigate radio broadcasts on the Internet. The musical preference may identify a song, artist, mood, time period, genre, and/or sub-genre. The song list may be compiled based on audio pattern analysis, peer group data, playlists, recommendations from a social network, or the like. A user may select another user to hear songs selected by that user. The user may vote, rate, or provide other feedback regarding the songs identified in the song list. The mobile device may display additional content associated with a song played.

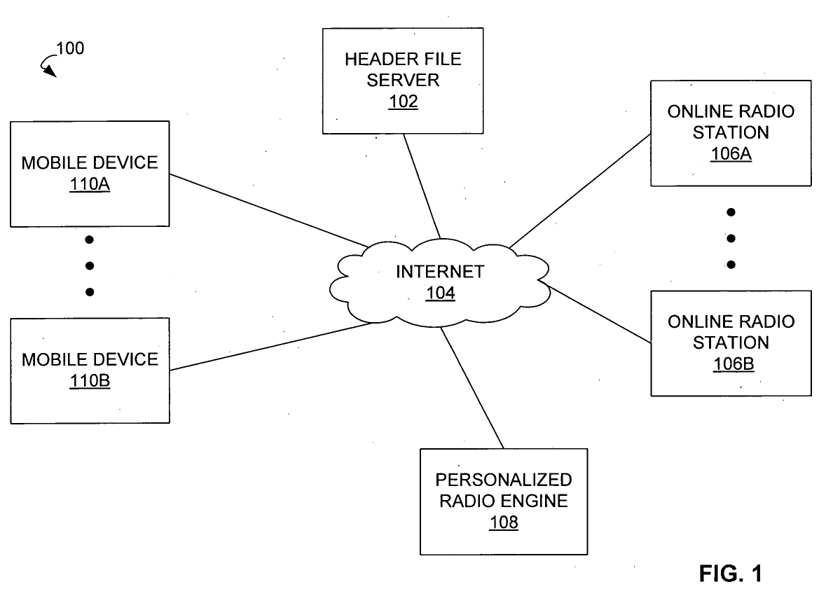

FIG. 1 depicts an exemplary environment 100 in which various embodiments of the present invention may be practiced. The environment 100 comprises a header file server 102, one or more online radio stations 106A and 106B, a personalized radio engine 108, and one or more mobile devices 110A and 110B capable of communicating with the header file server 102, the online radio stations 106A and 106B, and/or the personalized radio engine 108 via the Internet 104.

The header file server 102 is configured to scan header files associated with online radio stations 106A and 106B. The online radio stations 106A and 106B may be associated with URLs accessible via the Internet 104. The header file server 102 may comprise a crawler configured to crawl a list of URLs containing or linking to radio broadcasts hosted by online radio stations 106A and 106B. If online radio station 106A is identified, the header file server 102 may access the header file by accessing the URL, receiving a feed such as an RSS feed or an ATOM feed from the online radio station 106A, or otherwise accessing metadata associated with the online radio station 106A. The header file server 102 may process and/or transmit data extracted from the header files to the personalized radio engine 108.

The online radio stations 106A and 106B may comprise or be associated with streaming radio broadcasts accessible via the Internet 104. In some instances, the online radio station 106A may be associated with a terrestrial radio station. The online radio station 106A may be streamed using files formats such as MP3, Ogg Vorbis, Windows Media Audio, RealAudio, and/or HE-AAC. The online radio station 106A typically includes a header file that can be accessed by the header file server 102. The header file may include data such as source, URL, current song playing, or the like.

The personalized radio engine 108 is configured to process the header file data received from the header file server 102. Based on a musical preference, the personalized radio engine 108 generates one or more song lists associated with each of the mobile devices 110A and 110B. The personalized radio engine 108 compares real-time the header file data from the online radio station 106A to songs identified in a song list associated with the mobile device 110A. If there is a match, the personalized radio engine 108 transmits a link or other indicator to the mobile device 110A.

In some instances, the personalized radio engine 108 may identify more than one match. In these instances, the personalized radio engine 108 may rank the matches and/or select matches before transmitting a link to the mobile device 110A. In some embodiments, the personalized radio engine 108 may transmit multiple links to the mobile device 110A.

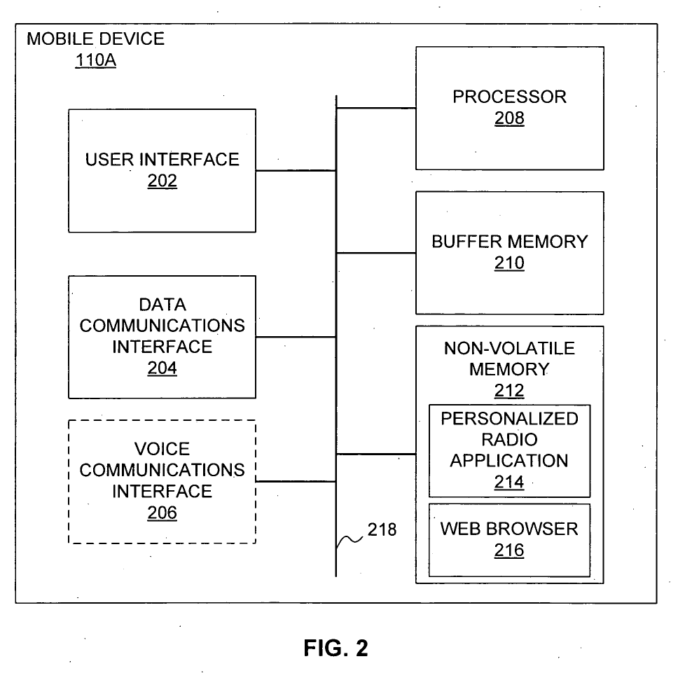

The mobile devices 110A and 110B are computing devices configured to communicate over the Internet. Examples of the mobile devices 110A and 110B include mobile telephones, personal digital assistants, personal media players such as an MP3 player, and the like. An exemplary mobile device is further described in connection with FIG. 2.

In operation, the header file server 102 identifies online radio stations 106A and 106B on the Internet 104. The personalized radio engine 108 receives an indication of a musical preference from a mobile device 110A. Based on the musical preference, the personalized radio engine 108 generates a song list comprising a listing of songs and/or artists related to the musical preference. The personalized radio engine 108 compares the song list to the header files scanned by the header file server 102. If the personalized radio engine 108 identifies a match, a “proposal” indicating the match is transmitted to the mobile device 110A associated with the musical preference. The proposal identifies the matching song(s) and includes an interface for the user to select a song. The songs identified in the proposal are displayed to the user, who may select the song. The mobile device 110A plays the selected song by navigating to a URL associated with the online radio station 106A that is currently streaming the song according to the header file. Based on feedback indicating which songs a user selects or rejects, the song lists and/or memory associated with the musical preference may be modified.

FIG. 2 is a block diagram of an exemplary mobile device 110A according to one embodiment of the present invention. The mobile device 110A comprises a user interface 202, a data communications interface 204, an optional voice communications interface 206, a processor 208, a buffer memory 210, and a non-volatile memory 212 connected by a bus 218.

The user interface 202 enables the user to interact with the mobile device 110A and may comprise a display, a speaker, a keypad, and/or a microphone. The data communications interface 204 is configured to transmit and receive data wirelessly using, for example, third generation wireless (3G) technology, a wireless local area network (WLAN) such as a wireless fidelity (WiFi)-compatible network, or other wireless data communications network. The optional voice communications interface 206 is configured to communicate over a cellular or other voice communications network for voice calling. The processor 208 is configured to execute instructions stored in the buffer memory 210 and the non-volatile memory 212. The buffer memory 210 comprises a re-writeable memory such as random access memory (RAM) or Flash memory. The non-volatile memory 212 may comprise read-only memory (ROM) and/or Flash memory.

A personalized radio application 214 is stored in the non-volatile memory 212. The personalized radio application 214, as discussed herein, is a program executable by the processor 208 to transmit a musical preference to the personalized radio engine 108, process selections received from the user, and receive links to the radio broadcasts 110A and 110B. The personalized radio application 214 may direct the processor 208 to store streaming data in the buffer memory 210.

In some embodiments, the mobile device 110A may also comprise a web browser 216 stored in the non-volatile memory 212. The web browser 216 is configured to access content published on the Internet 104 by navigating to a URL and/or otherwise access the online radio station 106A using the data communications interface 204. The personalized radio application 214 may further transmit data to and/or receive data from the personalized radio engine 108 by navigating to a URL associated with the personalized radio engine 108. In some embodiments, the personalized radio application 214 may be combined with the web browser 216. The web browser 216 may further include a media player configured to play the online radio station 106A on the mobile device 110A.

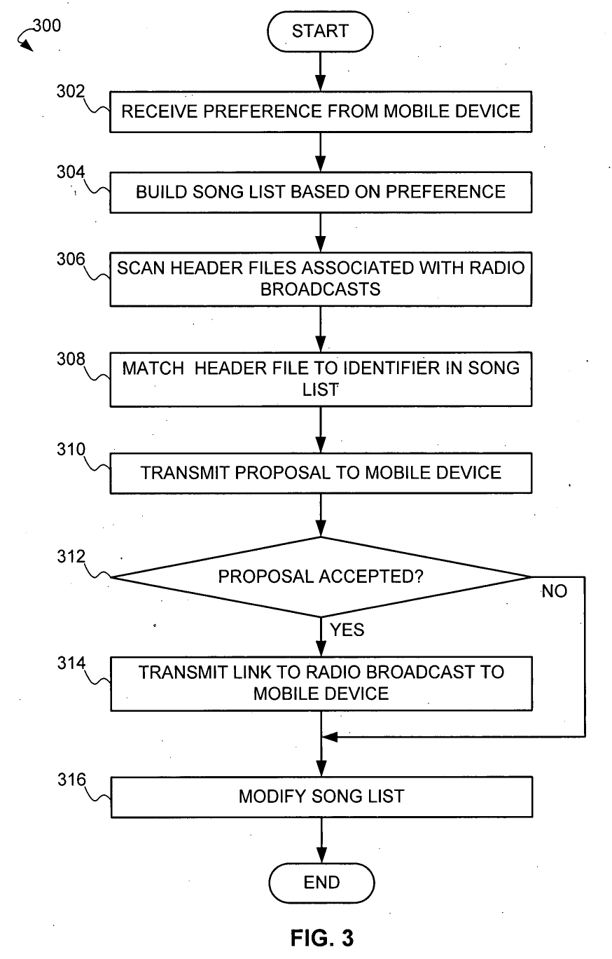

FIG. 3 is a flowchart 300 showing the major steps of providing a personalized music service using multiple online radio broadcasts to a mobile device according to various embodiments of the invention. The steps of flowchart 300 may be performed by the personalized radio engine 108 and/or the header file server 102 of FIG. 1.

In step 302, a musical preference is received from a mobile device, such as mobile device 110A. The musical preference may comprise a specific song or artist, a genre and/or sub-genre, a time period, mood, or any combination of these preferences. Further, a musical preference received from a user may be modified based on songs that the user has selected. Further types of musical preferences will be apparent to those skilled in the art. For example, the musical preference may be “ballads by Madonna.”

In step 304, the song list is built based on the musical preference. The song list may be built based on information received from one or more resources. The resources may include song lists that are publicly available, song lists generated within a social network, a song list associated with another user, musical pattern matching, selections made by other users with similar preferences, and/or the like.

The song list comprises a listing of identifiers associated with specific artists and/or songs related to the musical preference. Unlike a playlist, which specifies each song to be played to the user and the order in which the songs are played, the song list is a listing of songs that are related to the musical preference. A song on the song list is played to the user only if the song is broadcast according to the header file associated with a radio broadcast. The song list associated with the musical preference “ballads by Madonna” may include songs by, for example, Gwen Stefani or Kylie Minogue. Thus, if a song by Gwen Stefani is broadcast, the user may play the song. But if a song by Kylie Minogue is not broadcast, the user will not receive an option to play the Kylie Minogue song even though Kylie Minogue also appears on the playlist.

In some embodiments, the song list may include scores or rankings indicating that one song is more closely related to the musical preference than another. For example, on the “ballads by Madonna” playlist, songs by Gwen Stefani may have a higher score than songs by Shania Twain. If matches for both Gwen Stefani and Shania Twain are found at substantially the same time, the song by Gwen Stefani will be favored when a proposal is generated.

In step 306, the header files associated with radio broadcasts are scanned. The header files typically contain metadata about the audio stream associated with the radio broadcast. The metadata may comprise information such as source, URL, current song, current artist, music label, geographic location of the source, language associated with the source, or the like.

In step 308, the header file is matched to an identifier in the song list. The identifier may, for example, comprise a genre identifier, an artist identifier, and/or a song identifier. In some instances, more than one matching header file may be identified at substantially the same time. In these instances, scores associated with the matching header files may be compared or ranked. The ranking may be based on relevancy to the musical preference, frequency of being selected by other users or played by other radio broadcasts, or other musical preferences associated with the user.

In step 310, a proposal is transmitted to the mobile device. The proposal may include a dialogue that allows a user to accept or reject a specific song. Alternatively, the proposal may comprise a list of specific songs associated with multiple radio broadcasts. The proposal may include an image of an album cover and/or an artist, for example. In some embodiments, the proposal may include a link to one or more radio broadcasts.

In step 312, a message may be received indicating that the proposal was accepted by the user of the mobile device. In some embodiments, the proposal may be accepted by the user selecting one song of a listing of available songs.

If the proposal is accepted, a link to the radio broadcast is transmitted to the mobile device, in step 314. The link may comprise a URL or other data that allows the mobile device to access and/or play the radio broadcast. The other data may comprise login information, media player configuration, or the like. Visual content related to the song may also be transmitted to the mobile device as described in U.S. patent application Ser. No. 11/594,305 entitled, “Multi-Radio Mobile Application” which is incorporated herein by reference.

In step 316, the acceptance, rejection, or selection of a song may be used to modify the song list and/or other song lists associated with the same musical preference and/or similar musical preferences. To illustrate, the preference, “ballads by Madonna” may be associated with the preference “pop songs by Gwen Stefani.” A user with a musical preference of “ballads by Madonna” may be associated with a song list that includes a song by Shania Twain. If the user rejects the proposed Shania Twain song, other users who have “pop songs by Gwen Stefani” as a preference may have songs by Shania Twain removed from their song lists. In some embodiments, the accepted songs or the radio broadcasts playing the songs may be tracked and used as feedback.

In some embodiments, the geographical location of the source of the radio broadcasts accepted by the user may be tracked and/or displayed to the user. For example, a user may view a map of the sources of the radio broadcasts that the user has recently selected. For example, a user who has listened to radio broadcasts based in Mexico, Australia, and Germany may view a map indicating or highlighting these three countries.

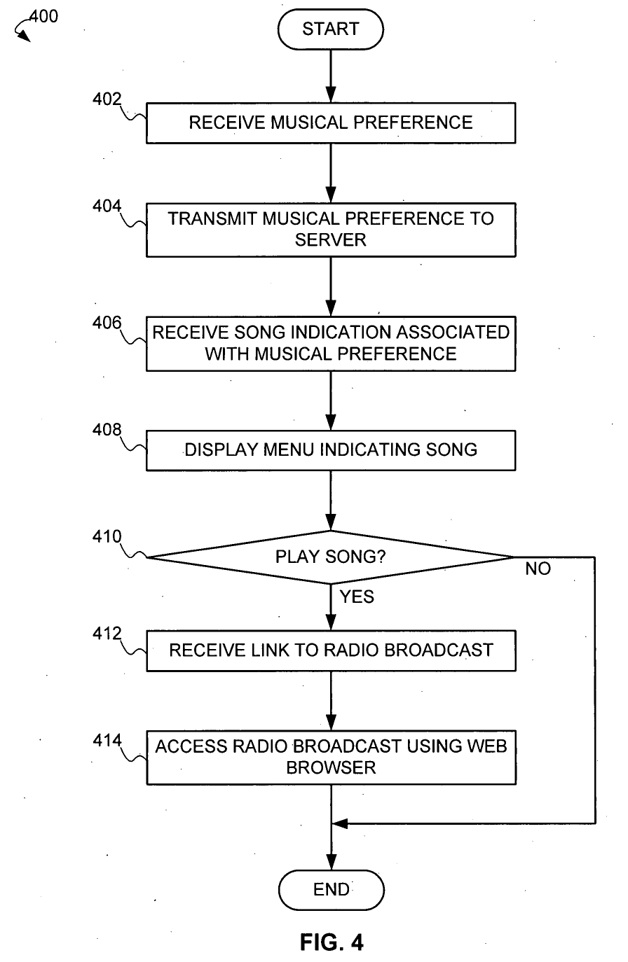

FIG. 4 is a flowchart 400 showing the major steps of receiving a personalized music service using multiple radio broadcasts on a mobile device according to various embodiments of the invention. The steps shown in flowchart 400 may be performed by the mobile device 110A.

In step 402, a musical preference is received from the user. The musical preference may be received by the user selecting an artist, song, genre, mood, music type or sound, or the like from a menu. In some embodiments, the user may designate a song or artist currently playing on a radio broadcast as a “preference.” In other cases, the preference may be inferred from music that the user has downloaded to the mobile device from other sources.

In some embodiments, the user may select another user's song list as a musical preference. For example, a user may play songs currently being selected by another user. In other embodiments, a user may select a song list assembled by a social network or online community. In step 404, the musical preference is transmitted to a server such as the personalized radio engine 108.

In step 406, a song indication associated with the musical preference is received. The song indication may comprise a song title, an artist, visual content associated with the song, a link to a radio broadcast, or the like. More than one song indication may be received according to some embodiments.

In step 408, a menu listing the song(s) specified by the song indication is displayed to the user. The menu may include an interface for the user to accept, reject, or select a song. The interface may also include a rating system that allows a user to rate a song. The rating system may be numeric or symbolic (e.g., thumbs up or thumbs down).

In step 410, an instruction is received from the user to play a song from the menu. In step 412, a link to the radio broadcast associated with the selected song is received from a server. In step 414, the radio broadcast is accessed by navigating to a URL associated with the link, and the song played. In some embodiments, the radio broadcast is accessed via a web browser. In instances where a song is currently being played, the current song may be faded out, and the-selected song then faded in and played on the mobile device. While the selected song is playing, additional menus may be displayed. The additional menus may be displayed at an interval or as songs on the song list become available.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for providing a personalized music service, comprising:
receiving an indication of a musical preference from a user of a mobile device;
generating a song list based at least in part on the musical preference, the song list comprising an identifier of a song associated with the musical preference;
scanning header files associated with one or more radio broadcasts;
selecting a radio broadcast having the identifier in its header file; and
transmitting a link associated with the radio broadcast to the mobile device.

2. The method of claim 1, further comprising:
receiving feedback from the mobile device regarding the radio broadcast; and
modifying the song list based upon the feedback.

3. The method of claim 2, further comprising modifying a memory to reflect the change in the musical preference.

4. The method of claim 1, wherein the song list is generated from information from a social network.

5. The method of claim 1, further comprising transmitting visual content associated with the header file to the mobile device.

6. The method of claim 1, wherein the radio broadcasts are accessible via the Internet and the link associated with a broadcast is a URL.

7. The method of claim 1, wherein the song list is also based in part on a second song list associated, with a second mobile device.

8. A method for receiving music via a personalized music service on a mobile device, comprising:
receiving a musical preference from a user;
transmitting a parameter indicating the musical preference to a server;
receiving an indication of a song associated with the musical preference on a radio broadcast from the server;
generating a menu indicating the song;
receiving an instruction from the user to play the song; and
playing the song based on the instruction.

9. The method of claim 8, wherein playing the song further comprises using a web browser to access the radio broadcast.

10. The method of claim 8, wherein the indication of the song is based at least in part on a social network associated with the user.

11. The method of claim 8, wherein the indication of the song is based in part on a second parameter associated with a second user.

12. The method of claim 8, further comprising displaying visual content associated with a source of the radio broadcast.

13. The method of claim 8, further comprising displaying a location associated with the radio broadcast.

14. A computer readable medium having embodied thereon a program, the program being executable by a processor for performing a method for providing a personalized music service, the method comprising:
receiving an indication of a musical preference from a user of a mobile device;
generating a song list based at least in part on the musical preference, the song list comprising an identifier of a song associated with the musical preference;
scanning header files associated with one or more radio broadcasts;
selecting a radio broadcast having the identifier in its header file; and
transmitting a link associated with the radio broadcast to the mobile device.

15. The computer readable medium of claim 14, wherein the method further comprises:
receiving feedback from the mobile device regarding the radio broadcast; and
modifying the song list based upon the feedback.

16. The computer readable medium of claim 15, wherein the method further comprises modifying a memory to reflect the change in the musical preference.
